(19) United States
(12) Patent Application Publication
(10) Pub. No.: US 2020/0042924 A1
(43) Pub. Date: Feb. 6, 2020

(54) VALIDATION SYSTEM, VALIDATION EXECUTION METHOD, AND VALIDATION PROGRAM

(71) Applicant: NEC CORPORATION, Tokyo (JP)

(72) Inventors: Yusuke MURAOKA, Tokyo (JP); Ryohel FUJIMAKI, Tokyo (JP)

(73) Assignee: NEC CORPORATION, Tokyo (JP)

(21) Appl. No.: 16/339,942

(22) PCT Filed: Sep. 8, 2017
(86) PCT No.: PCT/JP2017/032419

§ 371 Date: Apr. 5, 2019

(30) Foreign Application Priority Data
Oct. 7, 2016 (JP) 2016-199105

(51) Int. Cl. G06Q 10/06; G06Q 10/04; G06Q 10/10

(52) U.S. Cl. CPC G06Q 10/06393; G06Q 10/10; G06Q 10/04; G06Q 10/0637

(57) ABSTRACT

In a case where data including an input, first operation executed onto the input, and a first result obtained by the first operation is defined as validation data and data used in an evaluation target period is defined as test data, a density relation estimating unit 81 estimates a relationship between a density of a pair including an input of the validation data and the first operation onto the input and a density of the pair including an input of the test data and second operation to be executed onto the input. An expected result estimating unit 82 estimates a second result expected to be obtained by executing the second operation onto the input of the test data on the basis of the first result included in the validation data and the estimated relationship.

### TECHNICAL FIELD

The present invention relates to a validation system that evaluates future operation by using past data, a validation execution method, and a validation program.

### BACKGROUND ART

In the field of typical operational research, optimization in business operation is pursued, for example, by using a data strategy. Tryout of new operation, however, involves cost and risk, and thus, it is important to evaluate Key Performance Indicators (KPI) expected to be achieved by the new operation before actually performing the operation.

There is a similar issue, in a field of machine learning, of evaluating the performance of the predictor (model) before actual operation of the predictor. In the field of machine learning, there is a method, as a method of estimating the performance of a prediction model, in which past data (that is, data for which a correct solution value as a prediction target is known) is divided into training data and validation data, and the predictor that has performed learning by using the training data is evaluated by using the validation data.

The methods for evaluating the performance of the predictor in this manner include holdout verification and cross-validation (refer to Non Patent Literature 1 for cross-validation, for example). When the distribution of past data and the distribution of future data (that is, data for which the value of the correct solution as a prediction target is not known) are the same, it is possible to correctly estimate the prediction performance in a case where the predictor is applied to future data.

In addition, Non Patent Literature 2 describes a method for estimating the prediction performance of the predictor in a case where the past data distribution is different from the future data distribution.

### CITATION LIST

### Non Patent Literature

NPL 1: M. Stone, “Cross-Validatory Choice and Assessment of Statistical Predictions”, Journal of the Royal Statistical Society. Series B (Methodological), Vol. 36, No. 2, pp. 111-147, 1974
NPL 2: Masashi Sugiyama et al., “Direct Importance Estimation with Model Selection and Its Application to Covariate Shift Adaptation”, Advances in Neural Information Processing Systems 20 (NIPS 2007).

### SUMMARY OF INVENTION

### Technical Problem

In validation, data independent of learning data is used for evaluation, making it is possible to evaluate a predicted error without bias on the assumption that the assumed distribution would not change between learning data and evaluation data.

A preliminary evaluation of the operation optimization algorithm can be implemented as evaluation using past data for which a solution is known as evaluation data (that is, as validation data) similarly to the field of machine learning, as described as a method in Non Patent Literature 1. Specifically, the evaluation is preliminarily performed as a method of evaluating the operation generated by the optimization algorithm, by using past data not used for generation of the optimization algorithm.

For example, since the target customer in the past campaign and the effect of the campaign has been already obtained, it is possible to perform preliminary evaluation by defining the target customer in the past campaign and its result as an input and defining an effect to be obtained by application of a new operation to the customer as an output. Moreover, the past data can be data indicating operation (campaign) and its result (for example, whether the campaign has been cancelled).

The inventors of the present application, however, have found that evaluating an algorithm for determining the operation by simply using past data as validation data similarly to the evaluation of machine learning might produce a large bias (deviation from a real effect) in effect measurement. This issue will be described by using specific examples.

FIG. 15 is a diagram illustrating an example of a method for evaluating an effect of a campaign. Distribution D1 illustrated in FIG. 15 illustrates data distribution as a target in a past campaign, corresponding to validation section data. Distribution D2 illustrates data distribution as a target in the campaign after optimization, corresponding to data of a section as an evaluation target. Furthermore, as illustrated in FIG. 15, the distribution D1 is assumed to be distribution concentrated on customers with low average sales in the past, while the distribution D2 is a distribution concentrated on customers with high average sales in the past.

As illustrated in FIG. 15, a change in the operation performed in the existing campaign would change the distribution of the data as a target in the campaign in many cases. That is, as illustrated in FIG. 15, a change in the data distribution might lead to deviation in operation, or deviation in the input of the operation optimization algorithm.

Therefore, simply using the target data in the past campaigns as validation data would produce a bias in effect measurement as a result of variation in data distribution. In another case where common part data D3 alone is to be used for evaluation, it is also difficult to appropriately perform evaluation since data that can be used as validation data is limited to part of the data.

For example, it is supposed that an effect of the campaign is to be calculated as an average value of sales based on the target data. An effect E1 assumed in the campaign after the optimization should be calculated in the vicinity of the center of the distribution D2. However, in a case where can data that can be used is the common part data D3 alone, a calculated effect E2 would be calculated as the vicinity of the center of the data D3. This results in generation of a bias between the effect E1 and the effect E2.

The following is a description why it is difficult to simply apply the validation of machine learning to the preliminary evaluation of the operation optimization algorithm.

Validation of machine learning will be described. One of the objectives of machine learning is to obtain a predictor that can minimize a loss function 1 (f(x), y). An objective of evaluation is to evaluate a small possible a value l(f(x), y) that can be obtained in a case where future (unknown) data sets are applied to the predictor. Letting p^{test}(x, y)) be the probability density function of x and y in the future data, the purpose of the evaluation is to obtain an expected value expressed in the following Formula 1.

[Math. 1]

$${E}^{test} [ l ( f ( X ) , Y ) ] = \int {p}^{test} ( x , y ) l ( f ( x ) , y ) dxdy \qquad ( Formula 1 )$$

Validation is used for this evaluation. In a case where a predictor f is learned in the data set {xₙ^{train}, yₙ^{train}} (training set), the validation uses a sample {xₙ^{val}, yₙ^{val}} (validation set) that is independent of the training set. The distribution of the validation data set is assumed to be the same as the distribution of a part of the test data set. Accordingly, when p^{val}(x, y) is a probability density function of x, y in the training data set, the following Formula 2 is to be assumed.

p^{val}(x,y)=p^{test}(x,y) (Formula 2)

Based on this assumption, as a way of validation, an average of the validation set is to be used for evaluation. When the sample size N approaches infinity, the average value converges to the expected value of the test data as illustrated in the following Formula 3. The above is description of the validation of machine learning.

[Math. 2]

$$\frac{1}{N} {\sum }_{n = 1}^{N} l ( f ( {x}_{n}^{val} ) \cdot {y}_{n}^{val} ) \to {E}^{val} [ l ( f ( X ) , Y ) ] = {E}^{test} [ l ( f ( X ) , Y ) ] \qquad ( Formula 3 )$$

Next, the use of the validation method described above for the evaluation of operation will be considered. Validation in the evaluation of operation is similar to the validation in machine learning in that it uses data for which past results are known. That is, the validation data is data for which past results are known and is past data which is used as a reference. The test data used in evaluation of operation is the data for a period to be evaluated from that point and is the data for a section as an actual evaluation target.

Hereinafter, operation is determined by a certain rule and evaluation is to be performed toward the rules. The rule determines the operation aₙ to be performed on a sample n on the basis of an input xₙ of the sample n. Rules may be deterministic or probabilistic. Moreover, a variable corresponding to the result of aₙ (for example, an increase in sales in a case where a campaign is performed) will be defined as yₙ. At this time, it is assumed that an expected value of the loss function (profit by campaign) l(xₙ, aₙ, yₙ) determined from xₙ, aₙ, and yₙ in a test section in a case a rule is followed needs to be evaluated.

Evaluation of the operation needs operation data aₙ, and thus, the validation data set is assumed to be {xₙ, yₙ, aₙ}. In a case where it can be assumed that the distribution of the validation data set is the same as the distribution of the test data set, it is possible to use a method similar to the above.

However, in this case, the operation aₙ often changes depending on content of optimization. Therefore, p^{test}(aₙ|xₙ) will be different from p^{val}(aₙ|xₙ). Due to this distribution difference, the average loss function in the validation data set would not converge to the expected value E [1 (X, Y, A)] of the test data even when N comes close to infinity.

The present invention provides a validation system, a validation execution method, and a validation program that can perform evaluation of an operation determining algorithm by using validation data without theoretically generating a bias.

### Solution to Problem

A validation system according to the present invention includes: a density relation estimating unit that estimates a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and an expected result estimating unit that estimates a second result expected to be obtained by executing the second operation onto the input of the test data on the basis of the first result included in the validation data and the estimated relationship.

A validation execution method according to the present invention includes: estimating a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and estimating a second result expected to be obtained by executing the second operation onto the input of the test data on the basis of the first result included in the validation data and the estimated relationship.

A validation program according to the present invention a computer to execute: density relation estimating processing of estimating a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and expected result estimating processing of estimating a second result expected to be obtained by executing the second operation onto the input of the test data on the basis of the first result included in the validation data and the estimated relationship.

### Advantageous Effects of Invention

According to the present invention, in a case where the evaluation of the algorithm for determining the operation is performed by using the validation data, the evaluation can be performed without theoretically generating a bias.

### BRIEF DESCRIPTION OF DRAWINGS

FIG. 1 It depicts a block diagram illustrating a configuration example of a validation system according to a first exemplary embodiment of the present invention.

FIG. 2 It depicts a flowchart illustrating an operation example of the validation system according to the first exemplary embodiment.

FIG. 3 It depicts a diagram illustrating an example of a specific data flow of the validation system of the first exemplary embodiment.

FIG. 4 It depicts a block diagram illustrating a configuration example of a validation system according to a second exemplary embodiment of the present invention.

FIG. 5 It depicts a flowchart illustrating an operation example of the validation system according to the second exemplary embodiment.

FIG. 6 It depicts a diagram illustrating an example of a specific data flow of the validation system of the second exemplary embodiment.

FIG. 7 It depicts a diagram illustrating an example of a specific data flow of a validation system of a third exemplary embodiment.

FIG. 8 It depicts a diagram illustrating an example of previous month's data used in a specific example.

FIG. 9 It depicts a diagram illustrating an example of present month's data used in a specific example.

FIG. 10 It depicts a diagram illustrating an example of present month's data used in a specific example.

FIG. 11 It depicts a diagram illustrating an example of a result of validation performed by using previous month's data.

FIG. 12 It depicts a diagram illustrating an example of calculating a density ratio.

FIG. 13 It depicts a diagram illustrating another example of calculating a density ratio.

FIG. 14 It depicts a block diagram illustrating a summary of the validation system according to the present invention.

FIG. 15 It depicts a diagram illustrating an example of a campaign effect evaluating method.

### DESCRIPTION OF EMBODIMENTS

Hereinafter, exemplary embodiments of the present invention will be described with reference to the drawings.

In the following description, validation data represents data in which an input, operation performed onto the input, and its result are known. The test data represents data to be used in a period to be evaluated from the present moment (evaluation target period).

In the following description, an input indicating a feature of a sample will be denoted as x, operation onto the input will be denoted as a, and a result obtained by the operation will be denoted as y. In addition, an input indicating a feature of a sample included in the validation data, operation, and a result obtained will be denoted as x^{val}, a^{val}, and y^{val} respectively, and an input indicating a feature of test data, and operation will be denoted as x^{test} and a^{test}, respectively. Note that each of samples may be represented with an index n in some cases.

That is, the validation data includes the input x^{val}, the operation a^{val} (hereinafter also referred to as first operation) executed onto the input x^{val}, and the result y^{val} (hereinafter also referred to as first result) obtained by the operation a^{val}.

Moreover, the test data includes the input x^{test} and the operation a^{test} (hereinafter also referred to as second operation) to be executed onto the input x^{test}. Alternatively, however, the test data includes the input x^{test} and the operation a^{test} prepared in advance, and the operation a^{test} may be generated from the input x^{test} on the basis of a certain rule from the state where the input x^{test} is prepared. In a case where there is no input x^{test} for the period to evaluate, x^{val} may be used as the input x^{test}.

The following will describe as appropriate, as a specific example, a case where a company evaluates optimality of an advertisement for customers. The specific example aims to improve sales by optimizing content of an advertisement directed to each of customers. For example, there is an assumable case that it is determined to start a new advertisement strategy (for example, launching an advertisement targeted for selected customers who spend $50 or more a month) as a result of data analysis within a company. In this case, an aim is to evaluate a sales improvement rate and obtain a result by the operation performed on the basis of the new advertisement strategy.

In this case, the customer information (feature of the customer) as an input in launching the past campaign corresponds to xₙ^{val}, an advertisement history (or presence or absence of advertisement) conducted onto the customer corresponds to aₙ^{val}, and a result obtained by the advertisement (sales improvement etc.) corresponds to yₙ^{val}. A result of adding these for individual customers n would be defined as a final expected result. Examples of customer information (feature of customer) xₙ include customer's monthly consumption, an order history, and purchase demographic information of a product.

### First Exemplary Embodiment

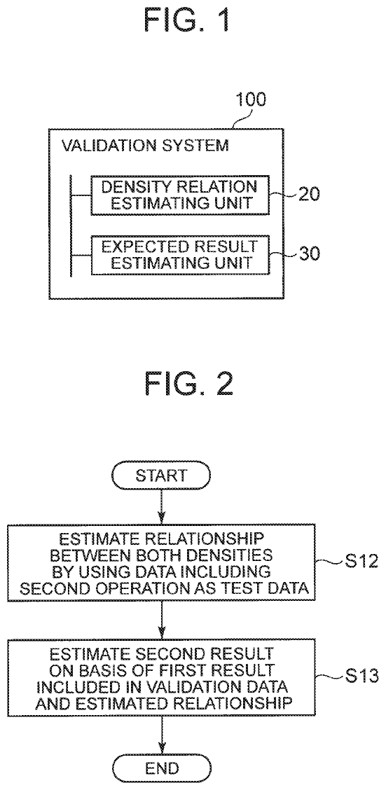

The first exemplary embodiment is a case where the input x^{test} and the operation a^{test} are prepared in advance (that is, with the input and operation being ready), and the distribution of the input of the test data and the distribution of the input of the validation data are mutually different. FIG. 1 is a block diagram illustrating a configuration example of a validation system according to the first exemplary embodiment of the present invention. A validation system 100 of the present exemplary embodiment includes a density relation estimating unit 20 and an expected result estimating unit 30.

The density relation estimating unit 20 estimates a relationship between a density of a pair {x^{val}, a^{val}} including an input of validation data and first operation onto the input and a density of a pair {x^{test}, a^{test}} including an input of test data and second operation onto the input.

The use of the relationship between both the densities estimated by the density relation estimating unit 20 enables evaluation of an algorithm using validation data to be performed without theoretically generating a bias. Methods for estimating the relationship between both the densities and the reasons will be described below.

The expected result estimating unit 30 estimates a result (hereinafter referred to as second result) expected to be obtained by execution of the second operation onto the input of the test data on the basis of the first result included in the validation data and the relationship estimated by the density relation estimating unit 20.

As described above, the evaluation method simply using the validation data would generate a bias in the evaluation result. In contrast, in the present exemplary embodiment, the expected result estimating unit 30 utilizes the relationship between both the densities estimated by the density relation estimating unit 20 so as to estimate the evaluation result without theoretically generating a bias in the evaluation.

Hereinafter, a method for estimating the relationship between both the densities will be specifically described. The density relation estimating unit 20 estimates a relationship between p^{val}(a|x)p^{val}(x) representing a density of a pair including an input of the validation data and the first operation onto the input and p^{test}(a|x)p^{test}(x) representing a density of an input of test data and the second operation onto the input. Specifically, the density relation estimating unit 20 defines γ(x, a) as a specific example of the relationship between both the densities as follows.

γ(x,a):=p^{test}(a|x)p^{test}(x)/p^{val}(a|x)p^{val}(x)

The above-described γ(x, a) can also be defined as a ratio of the density concerning the validation data and the density concerning the test data. Accordingly, γ(x, a) can be referred to as a density ratio. The density relation estimating unit 20 may estimate γ(x, a) by using the method described in Patent Literature 2, for example. Specific methods of calculating γ(x, a) have been extensively studied in the field of transfer learning, for example. Therefore, the density relation estimating unit 20 may estimate γ(x, a) by using any transfer learning method using {xₙ^{val}, aₙ^{val}} and {xₙ^{test}, aₙ^{test}}.

The expected result estimating unit 30 calculates the product of the first result (that is, the result yₙ^{val} obtained by executing the operation a^{val} onto the input x^{val}) and the density ratio, and then calculates a sum of the products calculated for each of the samples n as a second result (that is, an expected result). Specifically, the expected result estimating unit 30 estimates the second result on the basis of the following Formula 7.

[Math. 3]

$$\hat{l} = \frac{1}{N} {\sum }_{n = 1}^{N} γ ( {x}_{n}^{val} , {a}_{n}^{val} ) l ( {x}_{n}^{val} , {y}_{n}^{val} , {a}_{n}^{val} ) \qquad ( Formula 7 )$$

Here, it can be assumed that the validation data and the test data would not change as a result of performing operation aₙ onto a sample of a certain input xₙ, and thus, the following Formula 4 is assumed.

p^{test}(yₙxₙ,aₙ)=p^{val}(yₙ|xₙ,aₙ) (Formula 4)

On the other hand, since the distribution of operation is thought to vary depending on the content of optimization, the following Formula 5 is assumed. In Formula 5, p^{test}(aₙ|xₙ) corresponds to the algorithm to evaluate, and p^{val}(aₙ|xₙ) corresponds to the past operation strategy.

p^{test}(aₙ|xₙ)p^{val}(aₙ|xₙ) (Formula 5)

In the present exemplary embodiment, it is assumed that there is a difference in distribution of x, and thus, the following Formula 6 holds.

p^{test}(xₙ)≠p^{val}(xₙ) (Formula 6)

In addition, an evaluation function 1 of operation can be expressed as l(x, y, a). For example, in a case where the evaluation function represents a total revenue obtained by advertisement, it can be expressed as evaluation function l(x, y, a)=y−ca, where c is the cost of the advertisement. Accordingly, the aim of the evaluation can be set to obtain an expected value of the algorithm for the distribution p^{test}(x, y, a) of the test data, as indicated by the following Formula 8. That is, the expected result estimating unit 30 estimates the expected result as illustrated in Formula 8.

[Math. 4]

$${E}^{test} [ l ( X , Y , A ) ] = \int l ( x , y , a ) {p}^{test} ( x , y , a ) dxdyda \qquad ( Formula 8 )$$

Here, Formula 8 can be transformed as Formula 9 below on the basis of the assumptions of Formulas 4 and 5.

[Math. 5]

$$\begin{matrix}\begin{matrix}{E}^{test} [ l ( X , Y , A ) ] = \int {p}^{test} ( x , y , a ) l ( x , y , a ) dxdyda \\ = \begin{matrix}\int {p}^{test} ( y \vert x , a ) {p}^{test} ( a \vert x ) {p}^{test} ( x ) \\ l ( x , y , a ) dxdyda\end{matrix} \\ = \begin{matrix}\int {p}^{val} ( y \vert x , a ) {p}^{val} ( a \vert x ) {p}^{val} ( x ) \\ \frac{{p}^{test} ( a \vert x ) {p}^{test} ( x )}{{p}^{val} ( a \vert x ) {p}^{val} ( x )} l ( x , y , a ) dxdyda\end{matrix} \\ = \begin{matrix}\int {p}^{val} ( x , y , a ) \frac{{p}^{test} ( a \vert x ) {p}^{test} ( x )}{{p}^{val} ( a \vert x ) {p}^{val} ( x )} \\ l ( x , y , a ) dxdyda\end{matrix} \\ = {E}^{val} [ γ ( X , A ) l ( X , Y , A ) ]\end{matrix} & ( Formula 9 ) \\ where , γ ( x , a ) := \frac{{p}^{test} ( a \vert x ) {p}^{test} ( x )}{{p}^{val} ( a \vert x ) {p}^{val} ( x )} . & \end{matrix}$$

As illustrated in Formula 9, calculating γ(x, a) would lead to calculation of a value that converges to an evaluation value desired in the present exemplary embodiment, as illustrated in Formula 10 below. That is, with the execution of the above-described assumption, even in a case where the evaluation is performed using the validation data as illustrated in Formula 10, the evaluation can be performed without theoretically generating a bias.

[Math. 6]

$$\frac{1}{N} {\sum }_{n = 1}^{N} γ ( {x}_{n}^{val} , {a}_{n}^{val} ) l ( {x}_{n}^{val} , {y}_{n}^{val} , {a}_{n}^{val} ) \to {E}^{val} [ γ ( X , A ) l ( X , Y , A ) ] = {E}^{test} [ l ( X , Y , A ) ] \qquad ( Formula 10 )$$

The density relation estimating unit 20 and the expected result estimating unit 30 are implemented by a CPU of a computer operating in accordance with a program (validation program). For example, the program may be stored in a storage (not illustrated) included in the validation system 100, and the CPU may read the program and operate as the density relation estimating unit 20 and the expected result estimating unit 30 in accordance with the program. The density relation estimating unit 20 and the expected result estimating unit 30 may be individually implemented by dedicated hardware.

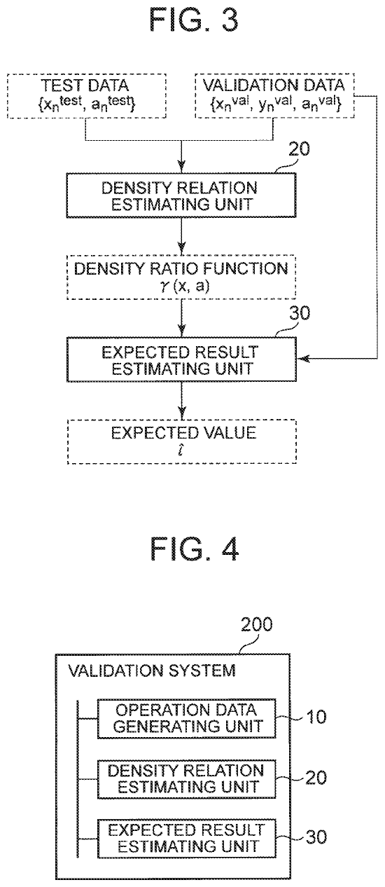

Next, operation of the validation system of the present exemplary embodiment will be described. FIG. 2 is a flowchart illustrating an operation example of the validation system according to the present exemplary embodiment. FIG. 3 is a diagram illustrating an example of a specific data flow of the validation system of the present exemplary embodiment.

The density relation estimating unit 20 estimates a relationship between both densities by using data including the second operation as test data (step S12). Specifically, the density relation estimating unit 20 estimates the density ratio function γ(x, a) from the test data {xₙ^{test}, aₙ^{test}} and the validation data {xₙ^{val}, aₙ^{val}}.

Next, the expected result estimating unit 30 estimates a second result on the basis of a first result included in the validation data and the relationship estimated by the density relation estimating unit 20 (step S13). The expected result estimating unit 30 estimates the second result on the basis of the above Formula 7, for example. Specifically, the expected result estimating unit 30 calculates an expected value l-hat (hat: \hat{ }) from the density ratio function γ(x, a) and the validation data {xₙ^{val}, yₙ^{val}, aₙ^{val}}.

As described above, in the present exemplary embodiment, the density relation estimating unit 20 estimates the relationship between the density of the pair including the input of the validation data and the first operation onto the input and the density of the pair including the input of the test data and the second operation onto the input. Next, the expected result estimating unit 30 estimates the second result expected to be obtained by executing the second operation onto the input of the test data on the basis of the first result included in the validation data and the estimated relationship.

Accordingly, in a case where the evaluation of the algorithm for determining the operation is performed by using the validation data, the evaluation can be performed without theoretically generating a bias. Specifically, campaigns that have been heuristically decided by a manager can now be determined after performing appropriate evaluation.

In addition, for example, in a case where a plurality of algorithms for determining the content of the campaign, a customer list for the period of implementation of the campaign and its feature amount exist, it is possible to use the validation system of the present exemplary embodiment to appropriately perform the evaluation.

### Second Exemplary Embodiment

Next, a second exemplary embodiment of the present invention will be described. The first exemplary embodiment assumed that the input x^{test} and the operation a^{test} are prepared in advance. In contrast, the present exemplary embodiment assumes a case where the operation a^{test} is generated from the input x^{test} on the basis of a certain rule from the state where the input x^{test} is prepared. That is, the present exemplary embodiment assumes evaluation of application of an operation rule in a state where the input x^{test} is prepared.

FIG. 4 is a block diagram illustrating a configuration example of a validation system according to the second exemplary embodiment of the present invention. A validation system 200 of the present exemplary embodiment includes an operation data generating unit 10, a density relation estimating unit 20, and an expected result estimating unit 30.

The operation data generating unit 10 generates operation aₙ^{test} of the test data on the basis of the rule of the operation to be applied. Specifically, the operation data generating unit 10 assigns the input x of the test data to the operation rule and generates the first operation aₙ^{test} to be applied. For example, when the operation rule to be applied is opt, aₙ^{test}=opt(xₙ^{test}).

The operation rule may have any content as long as it is a rule capable of determining the operation content on the basis of an input indicating the features of the test data. The operation rule may be a rule for determining the first operation to be applied to each of inputs x, or may be a rule for determining the first operation to be applied to inputs x of the whole test data.

Note that the operation data generating unit 10 may determine the second operation to maximize the estimated result. In other words, the operation data generating unit 10 may optimize the second operation so that the second result obtained with response to the input of the test data is maximized (optimum solution). Any method including widely known methods may be used as an optimization method.

Details of the density relation estimating unit 20 and the expected result estimating unit 30 are similar to those of the first exemplary embodiment.

The operation data generating unit 10, the density relation estimating unit 20, and the expected result estimating unit 30 are implemented by a CPU of a computer that operates in accordance with a program (validation program). For example, the program may be stored in a storage (not illustrated) included in the validation system 100, and the CPU may read the program and operate as the operation data generating unit 10, the density relation estimating unit 20 and the expected result estimating unit 30 in accordance with the program. The operation data generating unit 10, the density relation estimating unit 20, and the expected result estimating unit 30 may be individually implemented by dedicated hardware.

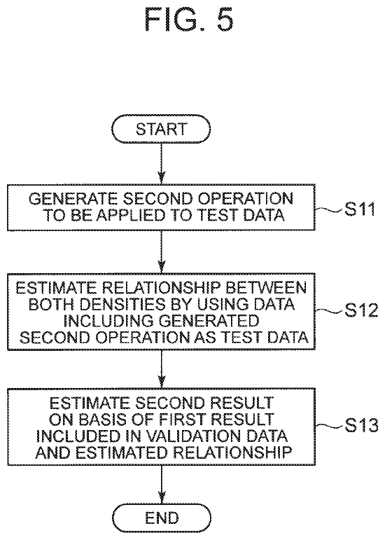

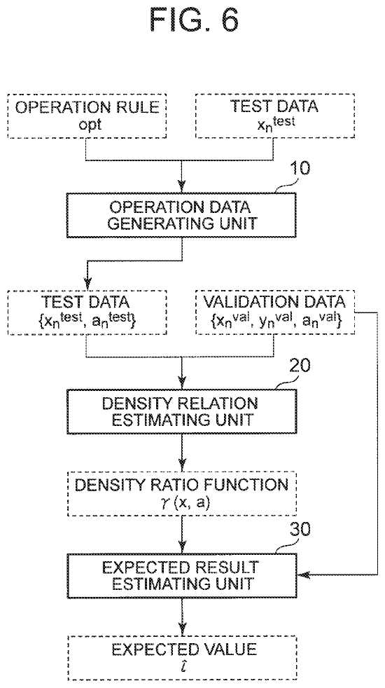

Next, operation of the validation system of the present exemplary embodiment will be described. FIG. 5 is a flowchart illustrating an operation example of the validation system according to the present exemplary embodiment. FIG. 6 is a diagram illustrating an example of a specific data flow of the validation system of the present exemplary embodiment. The operation data generating unit 10 assigns an input indicating the feature of the test data to an operation rule and generates second operation to be applied (step S11). More specifically, the operation data generating unit 10 generates test data {xₙ^{test}, aₙ^{test}} including the result aₙ^{test} of application of an operation rule from an operation rule opt and the test data xₙ^{test}.

Subsequent processing in which the density relation estimating unit 20 estimates the relationship between both densities and the expected result estimating unit 30 estimates the second result is similar to the processing of steps S12 to S13 illustrated in FIG. 2.

As described above, in the present exemplary embodiment, the operation data generating unit 10 assigns the input indicating the feature of the test data to the operation rule and generates the second operation to be applied. Therefore, the second operation to be applied can be automatically generated by defining an operation rule, in addition to the effects of the first exemplary embodiment.

### Third Exemplary Embodiment

Next, a third exemplary embodiment of the present invention will be described. The first exemplary embodiment and the second exemplary embodiment have described the case where the input x^{test} in the period as an evaluation target exists. The present exemplary embodiment will be described as a case where there is no input x^{test} in a period as an evaluation target.

The validation system of the present exemplary embodiment is similar to the second exemplary embodiment in terms of configuration. That is, similarly to the second exemplary embodiment, the operation data generating unit 10 assigns the input x of the test data to the operation rule and generates the first operation aₙ^{test} to be applied.

However, operation rules are normally different from each other at the time of evaluation, resulting in mutually different distribution of the validation data and the distribution of the test data.

In addition, the first operation generated in the present exemplary embodiment is operation determined onto the input similar to the distribution of the feature x^{val} of the validation data. Accordingly, the first operation will be described as aₙ^{val,opt} in some cases. This leads to: aₙ^{val,opt}=opt(xₙ^{test}).

Furthermore, similarly to the above exemplary embodiment, the density relation estimating unit 20 of the present exemplary embodiment also estimates the relationship between both densities, and the expected result estimating unit 30 estimates the second result expected to be obtained by execution of the second operation onto the input of the test data.

In the present exemplary embodiment, it can be assumed that the relationship of the above Formula 4 holds as well. Meanwhile, in the present exemplary embodiment, it is assumed that the distribution of x is similar, and the following Formula 11 is assumed.

p^{test}(xₙ)=p^{val}(xⁿ) (Formula 11)

Moreover, the expected result estimating unit 30 estimates the expected result as illustrated in Formula 8 in the present exemplary embodiment as well. Here, according to the assumptions of Formulas 4 and 11, Formula 8 can be transformed as Formula 12 below.

[Math. 7]

$$\begin{matrix}\begin{matrix}{E}^{test} [ l ( X , Y , A ) ] = \int {p}^{test} ( x , y , a ) l ( x , y , a ) dxdyda \\ = \begin{matrix}\int {p}^{test} ( y \vert x , a ) {p}^{test} ( a \vert x ) {p}^{test} ( x ) \\ l ( x , y , a ) dxdyda\end{matrix} \\ = \begin{matrix}\int {p}^{val} ( y \vert x , a ) {p}^{val} ( x ) {p}^{val} ( a \vert x ) \\ \frac{{p}^{test} ( a \vert x )}{{p}^{val} ( a \vert x )} l ( x , y , a ) dxdyda\end{matrix} \\ = \begin{matrix}\int {p}^{val} ( x , y , a ) \frac{{p}^{test} ( a \vert x )}{{p}^{val} ( a \vert x )} \\ l ( x , y , a ) dxdyda\end{matrix} \\ = {E}^{val} [ {γ}^{′} ( X , A ) l ( X , Y , A ) ]\end{matrix} & ( Formula 12 ) \\ where , {γ}^{′} ( x , a ) := \frac{{p}^{test} ( x , a )}{{p}^{val} ( x , a )} = \frac{{p}^{test} ( a \vert x )}{{p}^{val} ( a \vert x )} . & \end{matrix}$$

As illustrated in Formula 12, similarly to the first exemplary embodiment, calculating γ′(x,a) would lead to calculation of a value that converges to an evaluation value desired in the present exemplary embodiment, as illustrated in Formula 13 below.

[Math. 8]

$$\frac{1}{N} {\sum }_{n = 1}^{N} {γ}^{′} ( {x}_{n}^{val} , {a}_{n}^{val} ) l ( {x}_{n}^{val} , {y}_{n}^{val} , {a}_{n}^{val} ) \to {E}^{val} [ {γ}^{′} ( X , A ) l ( X , Y , A ) ] = {E}^{test} [ l ( X , Y , A ) ] \qquad ( Formula 13 )$$

γ′(x, a) is includes p^{val}(a|x) representing the density of the pair including the input of the validation data and the first operation onto the input and includes p^{test}(a|x) representing the density of the pair including the input of the test data and the second operation onto the input. Accordingly, the density relation estimating unit 20 calculates γ′(x, a) as the relationship between both densities.

Similarly to the first exemplary embodiment, the density relation estimating unit 20 may estimate the above-described γ′ by using the method described in NPL 2. Alternatively, the density relation estimating unit 20 may estimate γ′ by using any transfer learning method using {xₙ^{val}, aₙ^{val}} and {xₙ^{val}, aₙ^{val,opt}}.

The expected result estimating unit 30 estimates the second result on the basis of the following Formula 14.

[Math. 9]

$$\hat{l} = \frac{1}{N} {\sum }_{n = 1}^{N} {γ}^{′} ( {x}_{n}^{val} , {a}_{n}^{val} ) l ( {x}_{n}^{val} , {y}_{n}^{val} , {a}_{n}^{val} ) \qquad ( Formula 14 )$$

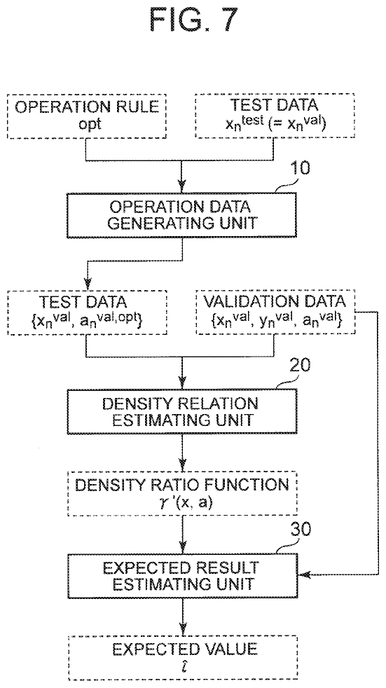

Next, operation of the validation system of the present exemplary embodiment will be described. The operation of the validation system of the present exemplary embodiment is similar to the operation of the second exemplary embodiment. FIG. 7 is a diagram illustrating an example of a specific data flow of the validation system of the present exemplary embodiment. The operation data generating unit 10 generates test data {xₙ^{val}, aₙ^{val,opt}} including the result aₙ^{test} of application of an operation rule from the operation rule opt and the test data xₙ^{test} having the distribution similar to the validation data xₙ^{val}.

The density relation estimating unit 20 estimates the density ratio function γ′(x, a) from the test data {xₙ^{val}, aₙ^{val,opt}} and the validation data {xₙ^{val}, aₙ^{val}}. The expected result estimating unit 30 calculates an expected value l-hat (hat: \hat{ }) from the density ratio function γ′(x, a) and the validation data {xₙ^{val}, yₙ^{val}, aₙ^{val}}.

As described above, in the present exemplary embodiment, the density relation estimating unit 20 estimates the relationship between both densities by using the input having the same distribution of the features of the test data as the distribution of the features of the validation data. Even in this case, it is also possible to perform evaluation without theoretically generating a bias.

In other words, the validation system of the present exemplary embodiment is applicable in a case where it is desired to perform evaluation when there is no specific test data while the distribution of x is similar to that of the validation data.

For example, it is possible to use the validation system of the present exemplary embodiment in the case of using data for determination of distribution target customers in the past and evaluating effects that could have been obtained by adopting the own company's algorithm in the same period, or evaluating future effects to be obtained by adopting the own company's algorithm in a case where the customer's profile has not changed.

Hereinafter, specific examples of the present invention will be described. The specific example assumes a scene of performing preliminary evaluation for a cancellation prevention campaign. It is assumed that the campaign up to the last time has been conducted to customers who are about to cancel at manager's intuition. It is also assumed that decision was made on the next campaign that “the campaign is to be conducted in descending order of usage fee (assuming seven customers)” and value is calculated on the basis of a result of the previous campaign.

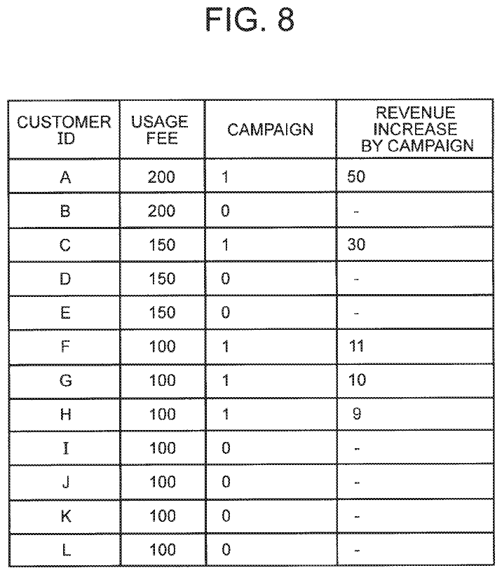

FIG. 8 is a diagram illustrating an example of previous month's data. FIG. 8 illustrates a usage fee, the presence or absence of a campaign, and an increase in revenue by a campaign, for 12 customers identified by customer ID. The usage fee illustrated in FIG. 8 corresponds to the above feature x, the presence or absence of a campaign corresponds to the operation a described above, and a revenue increase corresponds to the result y described above.

This specific example assumes that an average effect of a campaign conducted (a=1) on a customer with a usage fee of 200 (x=200) is a revenue increase by 50 (y=50). Similarly, it is assumed that an average effect of a campaign conducted on a customer with a usage fee of 150 is an increase in revenue by 30, and an average effect of a campaign conducted on a customer with a usage fee of 100 is a revenue increase by 10.

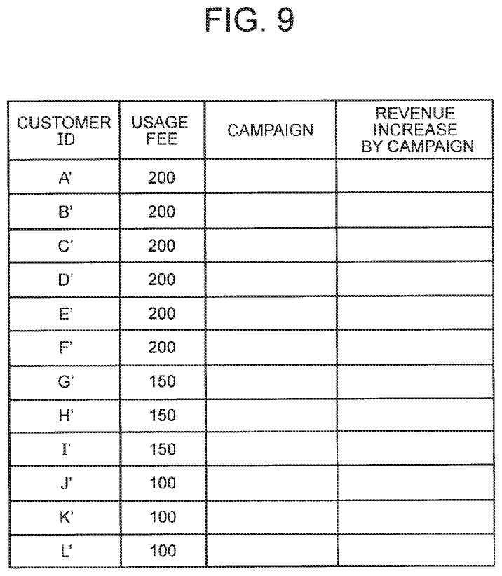

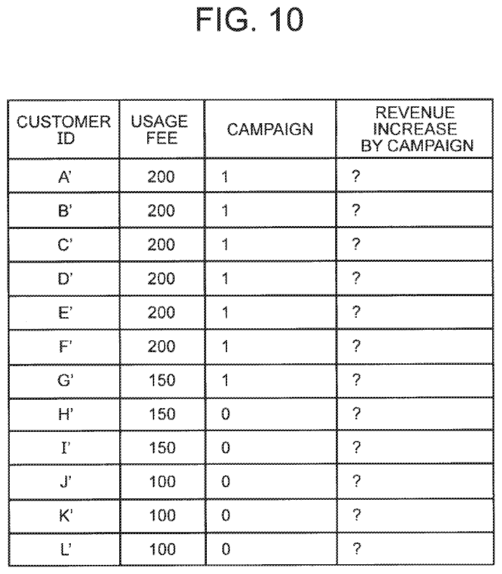

First, a first specific example will be described. In the first specific example, it is assumed that the profile of the customer in the next month will be different. FIGS. 9 and 10 are diagrams each illustrating an example of data of the present month. It is assumed that the present month has distribution of usage fee×different from the previous month as illustrated in FIG. 9. Since the campaign of the present month is determined to be “conducted in descending order of usage fee (here, seven customers)”, the operation data generating unit 10 determines to conduct the campaign from top seven customers, that is, A′ to G′, illustrated in FIG. 10.

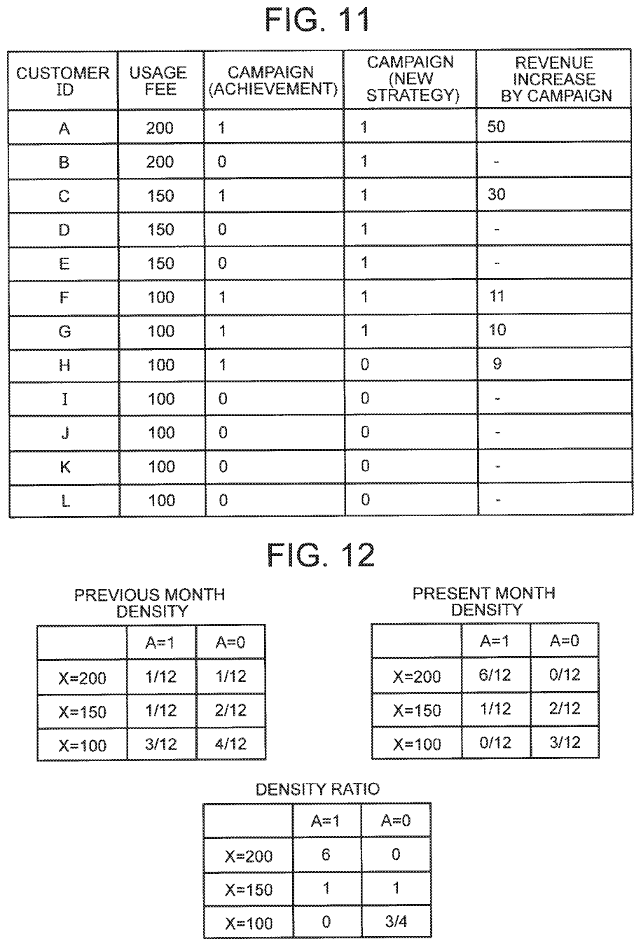

For comparison, a method of evaluating without calculating the relationship of densities will be described first. FIG. 11 is a diagram illustrating an example of the result of conducting validation using previous month's data. In the previous month's data, since the customers identified by customer IDs of A to G correspond to the top seven high usage fee customers. Accordingly, evaluation is performed assuming that the present month's campaign (new strategy) is conducted on these seven customers.

Here, the target customers of the campaign in the previous campaign (achievement) and the campaign of present month (new strategy) are A, C, F, and G. The total of the results of campaign conducted on these customers is calculated as 50+30+11+10.

Note that the result corresponds to evaluation of four campaigns alone out of seven campaigns to be conducted. Accordingly, for example, it is conceivable that correction is to be performed assuming that the average effect is equal (that is, multiplication by 7/4). This calculation leads to (50+30+11+10)×(7/4)=176.65.

In contrast, according to the revenue effect as an assumption of this specific example, the campaign is conducted on six customers with a usage fee of 200 and one customer with a usage fee of 150. Accordingly, the revenue increase is calculated as 50×6+30×1=330. It is observed that the bias is larger than the above result (176.65).

Next, a method of evaluating using the validation system of the present exemplary embodiment will be described. The density relation estimating unit 20 estimates the density ratio of the data of the previous month (corresponding to validation data) and the data of this month (that is, corresponding to the test data). Here, the density relation estimating unit 20 simply calculates the ratio of the density of the present month data to the density of the previous month data.

FIG. 12 is a diagram illustrating an example of calculating the density ratio. For example, there are 12 customers in the previous month and there is one customer (A=1) subjected to the campaign out of customers with a usage fee of 200 (X=200). Accordingly, the density corresponding to X=200 and A=1 out of the densities of the previous month is calculated as 1/12. Meanwhile, there are 12 customers in the present month and there are six customers (A=1) to be subjected to the campaign out of customers with a usage fee of 200 (X=200). Accordingly, the density corresponding to X=200 and A=1 out of the densities of the present month is calculated as 6/12. The similar can be applied to the others.

The ratio of the density of the present month to the density of the previous month is calculated as (6/12)/(1/12)=6. The similar can be applied to the others. As a result of this calculation, the density ratio illustrated in FIG. 12 is estimated from the data of the previous month illustrated in FIG. 8 and the present month data illustrated in FIG. 9.

Note that while this specific example is a case where X is a discrete value, it is allowed, in a case where X is a continuous value, that the density relation estimating unit 20 would estimate the density relationship by using transfer learning methods as described in Patent Literature 2.

Next, the expected result estimating unit 30 estimates an expected value from the estimated density ratio and the data of the previous month. In this specific example, the revenue effect is 50 and the density ratio is 6 in a case where the usage fee is 200. The revenue effect is 30 and the density ratio is 1 in a case where the usage fee is 150. The revenue effect is 10 and the density ratio is 0 in a case where the usage fee is 100. Accordingly, the expected result estimating unit 30 calculates 50×6.+30×1.+(11+10+9)×0.=330. as the expected value.

This is equal to the expected value calculated by the revenue effect assumed in this specific example, indicating that no bias has occurred.

In this specific example (and a second specific example described below), it is assumed that the variable x upon which the effect depends is known and the value x is a one-dimensional discrete value in order to explain that a bias easily occurs between the case of using the density ratio relationship and the case of not using the density ratio relationship. The value x used in the present invention, however, is not limited to one-dimensional discrete value. The value x may be, for example, a multidimensional variable or a continuous value.

Moreover, this specific example assumed that the variable X upon which the effect depends is a known, one-dimensional discrete value in order to explain that a bias easily occurs. Therefore, it is allowable to consider that there would be no problem as long as estimation of the effect is performed for each of X=200, 150, 100 in this example. However, in a case where X is a multidimensional continuous value, measuring an effect would need further creation of a model, leading to inclusion of modeling errors etc. Therefore, it is actually difficult to apply the method of estimating the effect for each of X.

Next, a second specific example will be described. In the second specific example, the profile of the customer in the next month is assumed to be the same as previous time (that is, the distribution of x would not change). The application scene of this specific example corresponds to a case where the distribution of x in the future is not known but the distribution of x is estimated to be the same as the past data.

The density relation estimating unit 20 estimates the density ratio between the previous month's data and the data in the case of implementing the new strategy onto the data of the previous month (the data will be referred to as present month data). Here, the density relation estimating unit 20 simply calculates the ratio of the density of the previous month data and the density of the present month data.

FIG. 13 is a diagram illustrating another example of calculating the density ratio. As illustrated in FIG. 13, the previous month density is not different from the density of the first specific example. In contrast, this specific example applies a rule of “conducting a campaign in descending order of usage fee (here, seven customers)” to the previous month data. In this case, the campaign target will be two customers with a usage fee of 200, three customers with a usage fee of 150, and two customers with a usage fee of 100. As a result, the present month density illustrated in FIG. 13 is calculated. The density ratio illustrated in FIG. 13 is calculated from the calculated previous month density and the present month density.

Next, the expected result estimating unit 30 estimates an expected value from the estimated density ratio and the previous month data. In this specific example, the revenue effect of the usage fee 200 is 50, and the density ratio is 2. The revenue effect of usage fee 150 is 30, and the density ratio is 3. The revenue effect of usage fee 100 is 10, and the density ratio is 2/3. Accordingly, the expected result estimating unit 30 calculates 50×2.+30×3.+(11+10+9)×2/3=210. as the expected value.

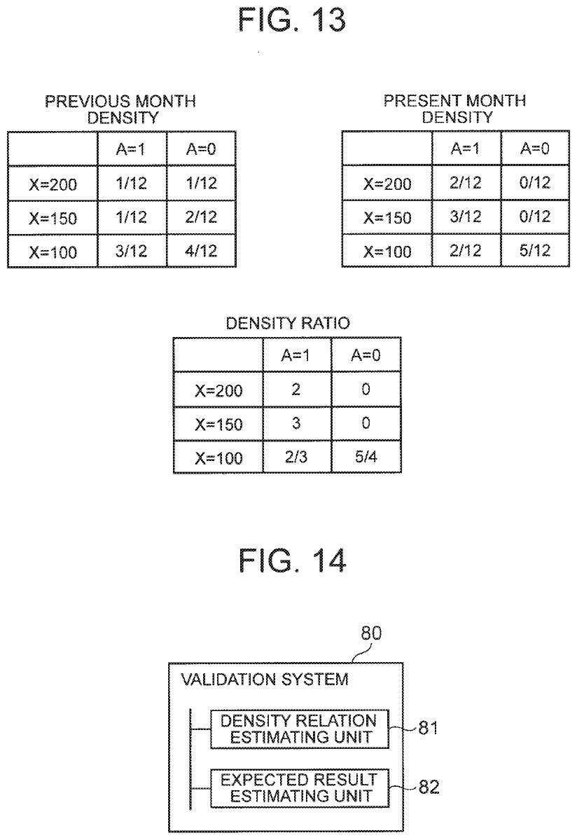

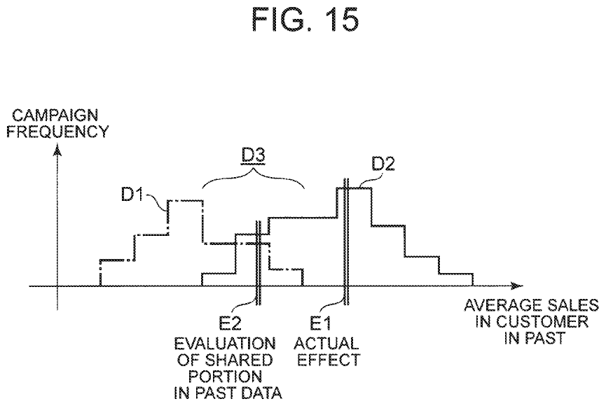

Next, a summary of the present invention will be described. FIG. 14 is a block diagram illustrating a summary of the validation system according to the present invention. In a case where data including an input (x^{val}, for example), first operation (a^{val}, for example) executed onto the input, and a first result (y^{val} for example) obtained by the first operation is defined as validation data and data used in an evaluation target period is defined as test data, a validation system 80 (validation system 100 or 200, for example) according to the present invention includes: a density relation estimating unit 81 (density relation estimating unit 20, for example) that estimates a relationship between a density of a pair including an input of the validation data and the first operation onto the input and a density of a pair including an input of the test data (x^{test}, for example) and second operation (a^{test}, for example) to be executed onto the input; and an expected result estimating unit 82 that estimates a second result (expected value l-hat, for example) expected to be obtained by executing the second operation onto the input of the test data on the basis of the first result included in the validation data and the estimated relationship.

With such a configuration, in a case where the evaluation of the algorithm for determining the operation is performed by using the validation data, the evaluation can be performed without theoretically generating a bias.

Moreover, the validation system 80 may include an operation data generating unit (for example, operation data generating unit 10) that assigns an input indicating a feature of test data to an operation rule (for example, opt) and generates second operation to be applied. In addition, the density relation estimating unit 81 may estimate the relationship between both the densities by using data including the generated second operation as test data.

With such a configuration, it is possible to uniquely determine the operation to be applied to each of pieces of test data.

Moreover, the density relation estimating unit 81 may estimate the relationship between both densities by using the input (p^{test}(xₙ)=p^{val}(xₙ), for example) having the same distribution of the features of the test data as the distribution of the features of the validation data.

With such a configuration, it is possible to appropriately evaluate operation onto data having identical distribution.

More specifically, the density relation estimating unit 81 may estimate the ratio of the density of a pair of the input of the validation data and the first operation for the input and the density of a pair of the input of the test data and the second operation on the input (for example, density ratio γ, γ′).

At this time, the expected result estimating unit 82 may calculate the product of the first result and the density ratio for each of input samples and may calculate the sum of the products as the second result.

The second operation may be a solution optimized to maximize the second result with respect to the input of the validation data.

As a specific example, the input is customer information, the first operation and the second operation are content of the campaign to be conducted on the customer, and the first result and the second result are the revenue by the campaign.

The above exemplary embodiments may also be partially or entirely described as the following appendices, although this is not a limitation.

(Supplementary note 1) A validation system comprises: a density relation estimating unit that estimates a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and an expected result estimating unit that estimates a second result expected to be obtained by executing the second operation onto the input of the test data on the basis of the first result included in the validation data and the estimated relationship.

(Supplementary note 2) The validation system according to Appendix 1, including an operation data generating unit that assigns an input indicating a feature of test data to an operation rule and generates second operation to be applied, in which the density relation estimating unit estimates a relationship between both the densities by using data including the generated second operation as test data.

(Supplementary note 3) The validation system according to Appendix 1 or 2, in which the density relation estimating unit estimates the relationship between both the densities by using the input having the same distribution of features of the test data as a distribution of features of the validation data.

(Supplementary note 4) The validation system according to any one of Appendices 1 to 3, in which the density relation estimating unit estimates a ratio of the density of a pair of the input of the validation data and the first operation on the input and the density of a pair of the input of the test data and the second operation on the input.

(Supplementary note 5) The validation system according to Appendix 4, in which the expected result estimating unit calculates a product of the first result and the density ratio for each of input samples and calculates a sum of the products as the second result.

(Supplementary note 6) The validation system according to any one of Appendices 1 to 5, in which the second operation is a solution optimized to maximize the second result with respect to the input of the validation data.

(Supplementary note 7) The validation system according to any one of Appendices 1 to 6, in which the input is customer information, the first operation and the second operation are content of a campaign to be conducted on a customer, and the first result and the second result are the revenue by the campaign.

(Supplementary note 8) A validation execution method comprises: estimating a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and estimating a second result expected to be obtained by executing the second operation onto the input of the test data on the basis of the first result included in the validation data and the estimated relationship.

(Supplementary note 9) The validation execution method according to Appendix 8, including: assigning an input indicating a feature of test data to an operation rule so as to generate second operation to be applied; and estimating a relationship between both the densities by using data including the generated second operation as test data.

(Supplementary note 10) A validation program that causes a computer to execute: density relation estimating processing of estimating a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and expected result estimating processing of estimating a second result expected to be obtained by executing the second operation onto the input of the test data on the basis of the first result included in the validation data and the estimated relationship.

(Supplementary note 11) The validation program according to Appendix 10, that causes a computer to execute operation data generating processing of assigning an input indicating a feature of test data to an operation rule and generating second operation to be applied, and causes the computer, in the density relation estimating processing, to estimate a relationship between both the densities by using data including the generated second operation as test data.

While the invention of the present application has been described with reference to the exemplary embodiments and examples, the invention of the present application is not limited to the above exemplary embodiments and examples. Configuration and details of the invention of the present application can be modified in various manners understandable for those skilled in the art within the scope of the invention of the present application.

This application is based upon and claims the benefit of priority from JP Provisional Application No. 2016-199105 filed Oct. 7, 2016, the disclosure of which is incorporated herein in its entirety by reference.

### INDUSTRIAL APPLICABILITY

The present invention is suitably applied to a validation system that compares a plurality of optimization algorithms and tunes parameters, for example. For example, the validation system of the present invention is applicable in a case where a cancellation prevention campaign is to be optimized and then in a case where profitability improvement of the campaign by the optimization is evaluated before actual implementation at cost. The validation system of the present invention is also applicable in comparing the operation with operation performed by another company, in addition to the operation comparison within the company.

### REFERENCE SIGNS LIST

10 Operation data generating unit
20 Density relation estimating unit
30 Expected result estimating unit

1. A validation system comprises:
a hardware including a processor;
a density relation estimating unit, implemented by the processor, that estimates a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and
an expected result estimating unit, implemented by the processor, that estimates a second result expected to be obtained by executing the second operation onto the input of the test data on the basis of the first result included in the validation data and the estimated relationship.

2. The validation system according to claim 1, comprising
an operation data generating unit, implemented by the processor, that assigns an input indicating a feature of test data to an operation rule and generates second operation to be applied,
wherein the density relation estimating unit estimates a relationship between both the densities by using data including the generated second operation as test data.

3. The validation system according to claim 1,
wherein the density relation estimating unit estimates the relationship between both the densities by using the input having the same distribution of features of the test data as a distribution of features of the validation data.

4. The validation system according to claim 1,
wherein the density relation estimating unit estimates a ratio of the density of a pair of the input of the validation data and the first operation on the input and the density of a pair of the input of the test data and the second operation on the input.

5. The validation system according to claim 4,
wherein the expected result estimating unit calculates a product of the first result and the density ratio for each of input samples and calculates a sum of the products as the second result.

6. The validation system according to claim 1,
wherein the second operation is a solution optimized to maximize the second result with respect to the input of the validation data.

7. The validation system according to claim 1,
wherein the input is customer information, the first operation and the second operation are content of a campaign to be conducted on a customer, and the first result and the second result are a revenue by the campaign.

8. A validation execution method comprises:
estimating a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and
estimating a second result expected to be obtained by executing the second operation onto the input of the test data on the basis of the first result included in the validation data and the estimated relationship.

9. The validation execution method according to claim 8, comprising:
assigning an input indicating a feature of test data to an operation rule so as to generate second operation to be applied; and
estimating a relationship between both the densities by using data including the generated second operation as test data.

10. A non-transitory computer readable information recording medium storing a validation program that causes, when executed by a processor, that performs a method for:
estimating a relationship between densities of two pairs, one density of a pair includes an input of validation data which includes an input, first operation executed onto the input, and a first result obtained by the first operation and the first operation onto the input, and the other density of a pair includes an input of test data which is used in an evaluation target period and second operation to be executed onto the input; and
estimating a relationship between a density of a pair including an input of the validation data and the first operation onto the input and a density of a pair including an input of the test data and second operation to be executed onto the input; and
estimating a second result expected to be obtained by executing the second operation onto the input of the test data on the basis of the first result included in the validation data and the estimated relationship.

11. The non-transitory computer readable information recording medium according to claim 10, comprising: assigning an input indicating a feature of test data to an operation rule so as to generate second operation to be applied, and
estimating a relationship between both the densities by using data including the generated second operation as test data.
